(19) United States
(12) Patent Application Publication
(10) Pub. No.: US 2024/0187764 A1
(43) Pub. Date: Jun. 6, 2024

(54) OPTICAL NETWORK UNIT AND POWER REDUCTION METHOD THEREFOR

(71) Applicant: Cortina Access, Inc., San Jose, CA (US)

(72) Inventor: Ryan Patrick Donohue, San Jose, CA (US)

(21) Appl. No.: 18/060,630

(22) Filed: Dec. 1, 2022

(51) Int. Cl. H04Q 11/00; H04B 10/50; H04J 14/02

(52) U.S. Cl. CPC H04Q 11/0067; H04B 10/503; H04J 14/0282

(57) ABSTRACT

An optical network unit (ONU) includes a media access control (MAC) circuit, a control circuit, and an optical element. The MAC circuit is configured to output upstream data and transmission time information. The transmission time information includes starting times and ending times of the upstream data. The control circuit is configured to receive the transmission time information and laser guard time information, start outputting laser diode (LD) driving signal a period before the starting time of the upstream data, and determine whether to stop outputting the LD driving signal after the ending time of the upstream data before the starting time of the next upstream data. The optical element is configured to output an output signal based on the upstream data and the LD driving signal. A power reduction method for an ONU is also provided.

### BACKGROUND

### Technical Field

The instant disclosure is related to an optical network unit, especially an optical network unit that can control driving of its transmitter so as to save power.

### Related Art

Passive Optical Networking (PON) is a popular technology for delivering networking connectivity over fiber. This technology is used in many FTTH (Fiber To the Home) and FTTB (Fiber to the Business) applications. In PON deployments, a box in the customer premises contains an ONU. The ONU consists of optics (a laser driver and laser receiver) and a PON media access control (MAC) which is implemented in a silicon chip. The silicon chip PON MAC controls the laser driver by modulating laser on/off under instructions given by the central office OLT.

Under normal conditions, the PON MAC produces three signals to the laser driver: the data signal being sent upstream, the BEN (burst enable) signal which the PON MAC generates to dynamically modulate the laser on/off, and a laser power signal which is used to statically control the laser in the operational state. The static power control signal is used to set up the laser for operation; it energizes the laser bias signal and configures the laser for operation.

However, when the laser is energized by the static power control signal, it burns static power even if the BEN signal modulation indicates that the laser is off. This waste of static power, when multiplied over tens of thousands or millions of ONUs deployed across the network, can contribute to a large amount of power waste.

### SUMMARY

To address the above issue, the instant disclosure allows the deployed ONU system to reduce the amount of power that is “wasted” by the laser driver during periods when the ONU is not actively transmitting. The instant disclosure does not change the PON protocol and therefore is invisible to other components in the system outside the ONU. As a result it can be deployed on some ONUs and not others without breaking the network or forcing a full network upgrade. Additionally, the instant disclosure contains capability to adapt to laser driver optics which have different characteristics (such as different power up or power down times).

In some embodiments, an ONU comprises a MAC circuit, a control circuit, and an optical element. The MAC circuit is configured to output a first upstream data, a second upstream data, and a transmission time information, wherein the transmission time information comprises a starting time of the first upstream data, an ending time of the first upstream data, and a starting time of the second upstream data. The control circuit is configured to receive the transmission time information and a laser guard time information; start outputting an laser diode (LD) driving signal a first time period before the starting time of the first upstream data, wherein the first time period is based on the transmission time information and the laser guard time information; and determine whether to stop outputting the LD driving signal based on the laser guard time information and a period between the ending time of the first upstream data and the starting time of the second upstream data. The optical element is configured to receive the first upstream data, the second upstream data, and the LD driving signal and output an output signal based on the first upstream data, the second upstream data, and the LD driving signal.

In some embodiments, a power reduction method for an ONU, comprises receiving, by a control circuit, a transmission time information and a laser guard time information, wherein the transmission time information comprises a starting time of the first upstream data, an ending time of the first upstream data, and a starting time of the second upstream data; starting outputting, by the control circuit, an LD driving signal a first time period before the starting time of the first upstream data, wherein the first time period is based on the transmission time information and the laser guard time information; determining, by the control circuit, whether to stop outputting the LD driving signal based on the laser guard time information and a period between the ending time of the first upstream data and the starting time of the second upstream data; receiving, by an optical element, the first upstream data, the second upstream data, and the LD driving signal; and outputting, by the optical element, an output signal based on the first upstream data, the second upstream data, and the LD driving signal.

As above, the instant disclosure allows the deployed ONU system to reduce power waste by timely turning off the laser driver. The instant disclosure does not change the PON protocol and thus can be deployed on any number of ONUs without requiring adjustment of the network. Additionally, the instant disclosure is capable of adapting to laser driver optics which have different characteristics.

### BRIEF DESCRIPTION OF THE DRAWINGS

The disclosure will become more fully understood from the detailed description given herein below for illustration only, and thus not limitative of the disclosure, wherein:

FIG. 1 illustrates a schematic block diagram of an optical network unit system according to an exemplary embodiment the instant disclosure;

FIG. 2 illustrates a schematic signal timing diagram of upstream data, burst enable signal, and laser diode driving signal according to an exemplary embodiment the instant disclosure; and

FIG. 3 illustrates a schematic flow chart of steps performed by a control circuit according to an exemplary embodiment the instant disclosure.

### DETAILED DESCRIPTION

The foregoing and other technical contents, features, and effects of the instant disclosure can be clearly presented below in detailed description with reference to embodiments of the accompanying drawings. Thicknesses or sizes of the elements in the drawings illustrated in an exaggerated, omitted, or general manner are used to help a person skilled in the art to understand and read, and the size of each element is not the completely actual size and is not intended to limit restraint conditions under which the instant disclosure can be implemented and therefore have no technical significance. Any modification to the structure, change to the proportional relationship, or adjustment on the size should fall within the scope of the technical content disclosed by the instant disclosure without affecting the effects and the objectives that can be achieved by the instant disclosure. In the following detailed description, the term “connect” may refer to any direct or indirect connection.

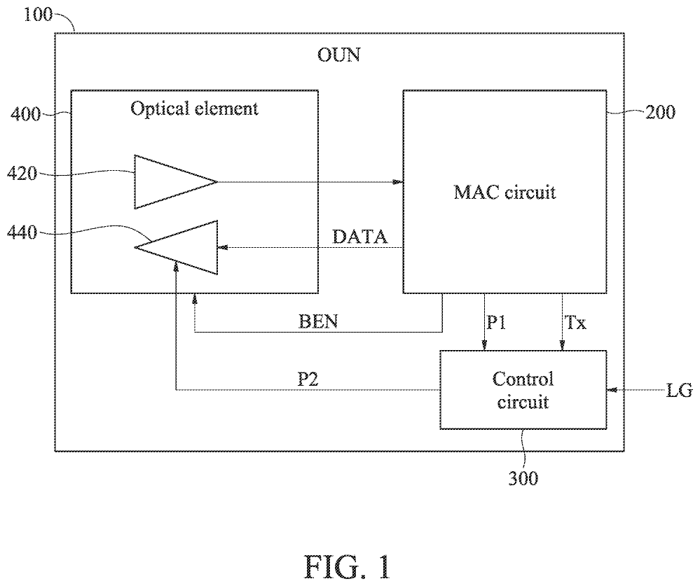

Please refer to FIG. 1. FIG. 1 illustrates a schematic block diagram of an optical network unit (ONU) system 100 according to an exemplary embodiment the instant disclosure. In some embodiments, the ONU system 100 comprises a MAC circuit 200, a control circuit 300, and an optical element 400.

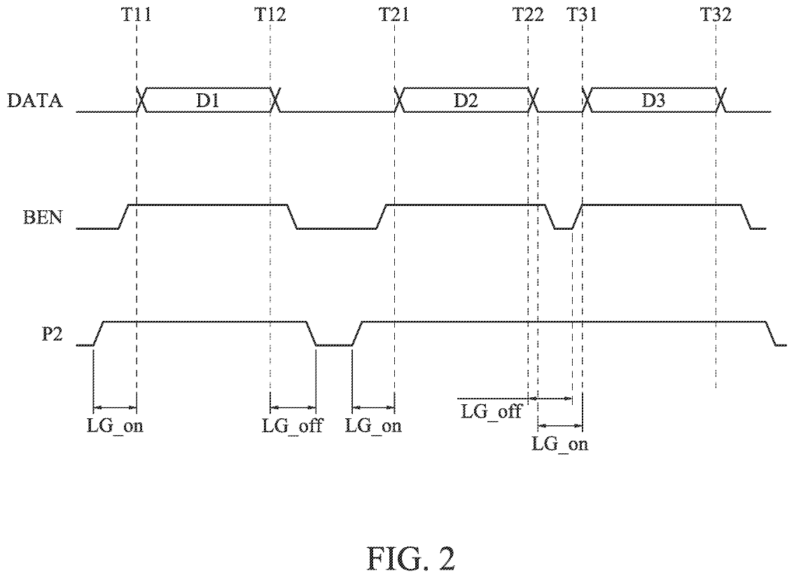

Please continue to refer to FIG. 1. The MAC circuit 200 is configured to output upstream data DATA, transmission time information Tx, a burst enable (BEN) signal, and a laser diode (LD) power signal P1. In some embodiments, the MAC circuit is a passive optical network (PON) MAC circuit. In the instant disclosure, for illustrative purposes, the MAC circuit 200 will output three upstream data DATA in the order of: the upstream data D1, the upstream data D2, and the upstream data D3. However, in practical application, the MAC circuit 200 may output any number of upstream data DATA as instructed. It should be noted that, in some embodiments, the upstream data DATA is outputted under the condition of burst mode. The transmission time information Tx comprises starting times T11, T21, T31 of the upstream data D1-D3 and ending times T12, T22, T32 of the upstream data D1-D3 (as shown in FIG. 2). In some embodiments, the transmission time information Tx is determined based time periods when the upstream data D1-D3 are outputted by the MAC circuit 200. In some embodiments, the transmission time information Tx is determined based time periods of the BEN signal generated by the MAC circuit 200. It is understood that the number of starting times and the number of ending times depend on the number of upstream data DATA scheduled to be outputted (for example, 3 in this this embodiment) and thus are neither limited to 3. The BEN signal enables burst mode of the optical element 400 for the transmission of upstream data D1-D3 and is only high around time periods when the upstream data D1-D3 are transmitted. The LD power signal P1 indicates when the transmission function of the MAC circuit 200 is activated. In other words, the LD power signal P1 is high throughout the time period when the transmission function of the MAC circuit 200 is activated.

Please continue to refer to FIG. 1. The control circuit 300 is configured to receive the transmission time information Tx, the LD power signal P1, and a laser guard time information LG and output a laser diode (LD) driving signal P2. The optical element 400 is powered on or off according to the LD driving signal P2. The control circuit 200 may be a finite state machine (FSM) or another device capable of performing the functions illustrated in the following description. The control circuit 300 learns that the transmission function of the MAC circuit 200 is activated based on the LD power signal P1. The control circuit 300 learns the starting times T11, T21, T31 of the upstream data D1-D3 and the ending times T12, T22, T32 of the upstream data D1-D3 based on the transmission time information Tx. The laser guard time information LG comprises laser on guard time LG_on and laser off guard time LG_off. The laser guard time information LG indicates time periods required for the laser device of a transmitter 440 of the optical element 400 to be turned on and turned off. The duration of the laser on guard time LG_on and the laser off guard time LG_off depends on the characteristics of the specific laser device deployed in the transmitter 440. The laser guard time information LG may be inputted to the control circuit 300 by a user through an interface device. Alternatively, the laser guard time information LG may be programmed in the MAC circuit 200 and inputted to the control circuit 300 by the MAC circuit 200. With the above information including the transmission time information Tx, the LD power signal P1, and the laser guard time information LG, the control circuit 300 can determine when it is acceptable not to output the LD driving signal P2, i.e., when the upstream data D1-D3 are not being transmitted.

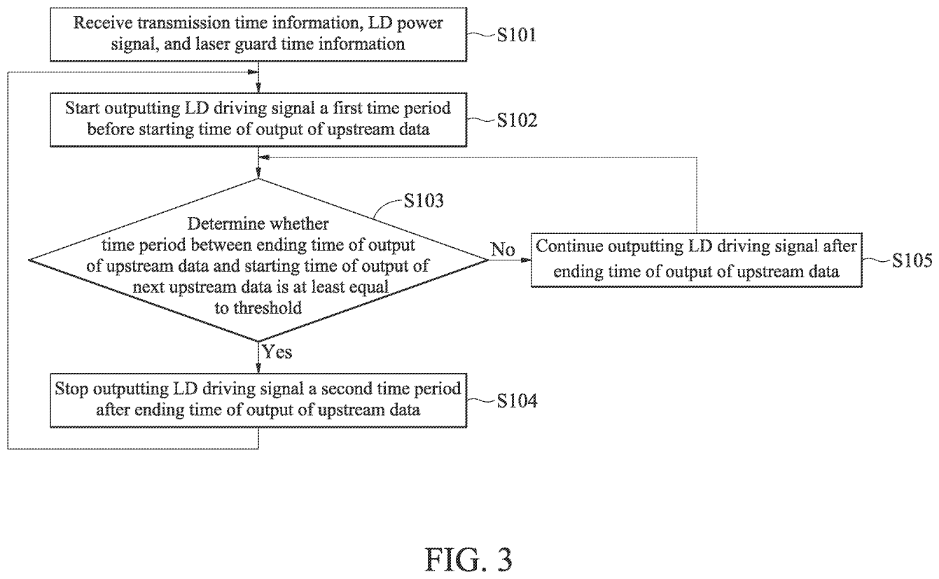

FIG. 2 illustrates a schematic signal timing diagram of upstream data D1-D3, BEN signal, and LD driving signal P2 according to an exemplary embodiment the instant disclosure. FIG. 3 illustrates a schematic flow chart of steps performed by the control circuit 300 according to an exemplary embodiment the instant disclosure. FIG. 2 and FIG. 3 will be used as an example for the illustration of the operation of the control circuit 300. First, in step S101, the control circuit 300 receives the transmission time information Tx, the LD power signal P1, and the laser guard time information LG and then proceed to step 102. In step S102, because the control circuit 300 knows that the upstream data D1 will start being outputted at the starting time T11 based on the transmission time information Tx, the control circuit 300 starts outputting the LD driving signal P2 a first time period before the starting time T11 and then proceed to step S103. The first time period is at least the laser on guard time LG_on so that the laser device of the transmitter 440 is powered on and fully ready before the upstream data D1 is outputted.

Next, in step S103, because the control circuit 300 knows that the upstream data D1 will stop being outputted at the ending time T12 and that the upstream data D2 still start being outputted at the starting time T21, the control circuit 300 can determine whether the time period between the ending time T12 and the starting time T21 is at least equal to a threshold. The threshold is at least the sum of the laser on guard time LG_on and the laser off guard time LG_off. In this embodiment, the threshold is equal to the sum of the laser on guard time LG_on and the laser off guard time LG_off. According to FIG. 2, because the time period between the ending time T12 and the starting time T21 is greater than the threshold, the control circuit 300 determines that it is acceptable to stop outputting the LD driving signal P2 between the ending time T12 and the starting time T21 and thus proceed to step S104. As a result, in step S104 the control circuit 300 stops outputting the LD driving signal P2 a second time period after the ending time T12 and then proceed to step S102. The second time period is at least the laser off guard time LG_off so that the upstream data D1 has been fully outputted before the laser device of the transmitter 440 is powered off. Then, in step S102, the first time period before the starting time T21, the control circuit 300 starts outputting the laser driving signal P2 again so that the laser device of the transmitter 440 is powered on and fully ready before the upstream data D2 is outputted.

In step S103, because the control circuit 300 knows that the upstream data D2 will stop being outputted at the ending time T22 and that the upstream data D3 still start being outputted at the starting time T31, the control circuit 300 can determine whether the time period between the ending time T22 and the starting time T31 is at least equal to the threshold. According to FIG. 2, because the time period between the ending time T22 and the starting time T31 is less than the threshold, the control circuit 300 determines that the time period between the ending time T22 and the starting time T31 may not be enough for the laser device of the transmitter 440 to be turned off and then turned on without disturbing the transmission of the upstream data D3. As a result, in step S105, the control circuit 300 does not stop outputting the LD driving signal P2 between the ending time T22 and the starting time T31 to ensure that the transmission of the upstream data D3 will not be affected. Finally for this embodiment, the MAC circuit 200 will stop outputting the LD power signal P1 to the control circuit 200 after all the scheduled upstream data D1-D3 have been transmitted, and thus the control circuit 300 also stops outputting the LD driving signal P2. It is understood that, if more upstream data are to be transmitted after the upstream data D1-D3, the MAC circuit 200 will not stop outputting the LD power signal P1 right after the upstream data D1-D3 are transmitted. As a result, the control circuit 300 can proceed to step S103 to determine whether the time period between the ending time of the upstream data D3 and the starting time of the upstream data immediately after the upstream data D3 is at least equal to the threshold and then proceed to step S104 or step S105 again, and so on.

To sum up the above operation, the control circuit 300 determines whether the time period between the ending time of one upstream data and the starting time of the next upstream data (such as the time period between the ending time T12 and the starting time T21 or the time period between the ending time T22 and the starting time T31) is at least equal to a threshold (which is at least the sum of the laser on guard time LG_on and the laser off guard time LG_off) to determine whether the LD driving signal P2 may be turned off without affecting the transmission of the upstream data DATA (such as the upstream data D1-D3) and control the LD driving signal P2 accordingly. This operation saves power that is, in prior art, wasted by the laser device of the transmitter 440 when the upstream data DATA is not being sent.

As above, the instant disclosure allows the deployed ONU system to reduce power waste by timely turning off the laser driver. The instant disclosure does not change the PON protocol and thus can be deployed on any number of ONUs without requiring adjustment of the network. Additionally, the instant disclosure is capable of adapting to laser driver optics which have different characteristics.

What is claimed is:

1. An optical network unit (ONU) comprising:
a media access control (MAC) circuit configured to output a first upstream data, a second upstream data, and a transmission time information, wherein the transmission time information comprises a starting time of the first upstream data, an ending time of the first upstream data, and a starting time of the second upstream data;
a control circuit configured to:
receive the transmission time information and a laser guard time information;
start outputting an laser diode (LD) driving signal a first time period before the starting time of the first upstream data, wherein the first time period is based on the transmission time information and the laser guard time information; and
determine whether to stop outputting the LD driving signal based on the laser guard time information and a period between the ending time of the first upstream data and the starting time of the second upstream data; and
an optical element configured to receive the first upstream data, the second upstream data, and the LD driving signal and output an output signal based on the first upstream data, the second upstream data, and the LD driving signal.

2. The optical network unit according to claim 1, wherein the laser guard time information comprises a laser on guard time, and the first time period is at least the laser on guard time.

3. The optical network unit according to claim 1, wherein, if the period between the ending time of the first upstream data and the starting time of the second upstream data is greater than or equal to a threshold, the control circuit stops outputting the LD driving signal a second time period after the ending time of the first upstream data.

4. The optical network unit according to claim 3, wherein the laser guard time information comprises a laser on guard time and a laser off guard time, and the threshold is at least the sum of the laser on guard time and the laser off guard time.

5. The optical network unit according to claim 1, wherein, if the period between the ending time of t the first upstream data and the starting time of t the second upstream data is less than a threshold, the control circuit does not stop outputting the LD driving signal after the ending time of the first upstream data before the starting time of the second upstream data.

6. The optical network unit according to claim 1, wherein the laser guard time information comprises a laser on guard time and a laser off guard time.

7. The optical network unit according to claim 1, wherein the transmission time information is determined based on a time period when the first upstream data is outputted by the MAC circuit and a time period when the second upstream data is outputted by the MAC circuit.

8. The optical network unit according to claim 1, wherein the transmission time information is determined based on time periods of a burst enable (BEN) signal generated by the MAC circuit.

9. The optical network unit according to claim 1, wherein the control circuit comprises a finite state machine.

10. The optical network unit according to claim 1, wherein the MAC circuit is configured to output a laser diode (LD) power signal to the control circuit, and the control circuit generates the LD driving signal according to the transmission time information, the laser guard time information, and the LD power signal.

11. The optical network unit according to claim 1, wherein the MAC circuit is configured to output a burst enable (BEN) signal to the optical element.

12. A power reduction method for an optical network unit (ONU), comprising:
receiving, by a control circuit, a transmission time information and a laser guard time information, wherein the transmission time information comprises a starting time of the first upstream data, an ending time of the first upstream data, and a starting time of the second upstream data;
starting outputting, by the control circuit, an LD driving signal a first time period before the starting time of the first upstream data, wherein the first time period is based on the transmission time information and the laser guard time information;
determining, by the control circuit, whether to stop outputting the LD driving signal based on the laser guard time information and a period between the ending time of the first upstream data and the starting time of the second upstream data;
receiving, by an optical element, the first upstream data, the second upstream data, and the LD driving signal; and
outputting, by the optical element, an output signal based on the first upstream data, the second upstream data, and the LD driving signal.

13. The method according to claim 12, wherein the laser guard time information comprises a laser on guard time, and the first time period is the laser on guard time.

14. The method according to claim 12, wherein, if the period between the ending time of the first upstream data and the starting time of the second upstream data is greater than or equal to a threshold, the control circuit stops outputting the LD driving signal a second time period after the ending time of the first upstream data, and the second time period is at least the laser off guard time.

15. The method according to claim 14, wherein the laser guard time information comprises a laser on guard time and a laser off guard time, and the threshold is at least the sum of the laser on guard time and the laser off guard time.

16. The method according to claim 12, wherein, if the period between the ending time of the first upstream data and the starting time of the second upstream data is less than a threshold, the control circuit does not stop outputting the LD driving signal after the ending time of the first upstream data before the starting time of the second upstream data.

17. The method according to claim 12, wherein the laser guard time information comprises a laser on guard time and a laser off guard time.

18. The method according to claim 12, wherein the transmission time information is determined based on a time period when the first upstream data is outputted by the MAC circuit and a time period when the second upstream data is outputted by the MAC circuit.

19. The method according to claim 12, wherein the transmission time information is determined based on time periods of a burst enable (BEN) signal generated by the MAC circuit.

20. An optical network unit (ONU) comprising:
a media access control (MAC) circuit configured to output a first upstream data, a second upstream data, and a transmission time information, wherein the transmission time information comprises a starting time of the first upstream data, an ending time of the first upstream data, and a starting time of the second upstream data;
a control circuit configured to receive the transmission time information and a laser on guard time and a laser off guard time, and output a laser diode (LD) driving signal according to the transmission time information and the laser on guard time and the laser off guard time;
an optical element, coupled to the MAC circuit and the control circuit, configured to receive the first upstream data, the second upstream data, and the LD driving signal, thereby transmitting the first upstream data and the second upstream data, wherein the optical element is powered on or off according to the LD driving signal.
